(19) United States
(12) Patent Application Publication
(10) Pub. No.: US 2015/0154651 A1
(43) Pub. Date: Jun. 4, 2015

(54) Streaming Content Delivery System and Method

(71) Applicants: Zia SHLAIMOUN, Malibu, CA (US); Bahram Brian PAYA, (US)

(72) Inventors: Zia Shlaimoun, Malibu, CA (US); Brian Bahram Paya, Los Angeles, CA (US)

(21) Appl. No.: 14/402,092

(22) PCT Filed: May 20, 2013
(86) PCT No.: PCT/US2013/041880

§ 371 Date: Nov. 18, 2014

Related U.S. Application Data
(60) Provisional application No. 61/649,197, filed on May 18, 2012.

(51) Int. Cl. G06Q 30/02

(52) U.S. Cl. CPC G06Q 30/0273

(57) ABSTRACT

An exemplary embodiment of a streaming content delivery system and method may deliver one or more static, dynamic and video advertisements or other marketing and sales content items to recipient computing devices which include, for example, cell phones and tablets. Content providers may pay the system to stream their content items to recipients, and the system may pay the recipient each time the content item is interacted with by the recipient by way of, for example, the content item being displayed on the recipient's device or the recipient actively clicking on or near the content. For accounting purposes, in certain embodiments the system and method may keep track of what content item is played on which computing device, and a counter may be provided to inform the respective recipient how much money the recipient has earned as a result of having watched or otherwise interacting with the content item.

### RELATED APPLICATIONS

This application is a U.S. National Stage of International Application No. PCT/US2013/041880, filed May 20, 2013, which claims the benefit of U.S. Provisional Application No. 61/649,197 filed May 18, 2012, the contents of each of which are incorporated by this reference in their entireties for all purposes as if fully set forth herein.

### TECHNICAL FIELD

The present invention relates generally to systems and methods for transmitting media content to the public. More particularly, the invention relates to systems and methods for delivering content while incentivizing the recipients' viewing of, and interaction with, the content.

### BACKGROUND

Effective advertising of products, programming or services to potential purchasers is essential to the success of most businesses. Similarly, effective promotion of a political or social message, or other informational campaign, is crucial for compelling recipients to act in accordance with the message. The effectiveness and efficiency of an advertising, informational or other media campaign is substantially improved when delivery of the related content is directed to those most likely to purchase the product or act on the information, and when mechanisms are employed which attract and maintain recipients' attention to the content. What is needed are improved systems and methods which allow content providers to more effectively deliver content to potential recipients, monitor the effectiveness of their campaign in an ongoing manner, and conveniently adapt and maximize their campaign budgets.

### SUMMARY

Certain deficiencies of the prior art may be overcome by the provision of embodiments of a Streaming Content Delivery (SCD) system and method. Such embodiments may deliver one or more static, dynamic and video advertisements and other marketing and sales content to devices which include, for example, cell phones, PDAs, Tablets and other mobile devices. By way of one or more embodiments, content providers may pay the system to stream their content, and SCD may pay the recipient each time the content is displayed on the recipient's device and/or each time the recipient actively replies or otherwise interacts with the content. The system, when active, may stream content sequentially from one or more content providers to a device until such time as the system is deactivated. For accounting purposes, in certain embodiments the system may keep track of what content is played on which device, and a counter may be provided to inform the recipient how much money the recipient has earned as a result of having watched the content. Particular embodiments of an SCD may further provide independent test marketing and other user data collected for providers on a proactive basis or through user behavior monitoring while the recipient watches and/or interacts with the content.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a block diagram of one embodiment of a system and method in accordance with the present invention, wherein C=content, i=information and $=money; and

FIG. 2 is a flow diagram generally depicting the steps of one example embodiment of a method in accordance with the present invention.

### DETAILED DESCRIPTION OF THE PREFERRED EMBODIMENTS

Described herein are various examples of systems and methods in accordance with the present invention. To more effectively teach the many ways in which the systems and methods may be configured and used, fundamental details of various preferred embodiments are presented from the perspective of the content provider, the content recipient and the system itself.

Preferred embodiments of a system and method in accordance with the present invention may allow a content provider to set up a provider account, set up a campaign, run a campaign, and receive certain post-campaign data.

Certain typical embodiments may include components or steps enabling a provider to set up a provider account. The provider may begin by, for example, visiting the SCD system website. If this is the first time the provider has visited the website, he may be asked to set up an account. The provider may then be asked to provide a means of payment, such as a credit and/or debit card or a credit account number. Providers already having credit facilities with the company operating the SCD system may be billed in regular periods, for example, on a weekly cycle. The provider is now ready to begin setting up new campaigns to stream advertisements or other media to recipients by submitting content to SCD for publication.

Particular embodiments may include components or steps enabling a provider to set up a campaign. For example, A provider may set up a new campaign and upload content to his account. The provider may choose whether he wants to pay for impressions or clicks or both. If the provider chooses to pay for clicks, then he may be required to designate where the recipient is sent (e.g., redirected) or what action is taken after the recipient clicks on the content, e.g. web address, product review etc. As the length of content may vary, an impression or click may be set or defined as a fixed amount of time, for example, a 10 second block of streamed content. Therefore, in certain example embodiments, content lasting 35 seconds, may consume four impressions or click blocks. The provider may then select any target audience information parameters such as demographic and geographic information and time slot. The provider may be charged a premium or provided a discount for each such parameter, based on the selected preferences. The provider may then select what amount he is prepared to pay for each impression and/or click. In certain embodiments, the higher the amount, the higher the priority the provider may have over other provider content. Note that in particular such embodiments, if the amount is too low, it is possible that the content will never be streamed or re-slated for a different time slot. The provider may be able to set a budget for the campaign. This may be a monitory figure which dictates how much the provider is prepared to spend on a campaign and once that budget is exhausted, the SCD system may be set to stop streaming the content and send notification to the provider. There may be unlimited or open-ended budgeting for preferred accounts and certain credit/charge card providers.

Certain embodiments may include components or steps enabling a provider to run a campaign. For example, once a campaign has been cleared by the SCD system, it may be marked as ‘ready for streaming’. The provider may then select a campaign designated for streaming and the SCD bills the provider the budget amount selected for that campaign. The provider may check the status and cost of a campaign that is currently running at any time. During the campaign, the provider may also be able to make changes to the campaign, for example, changes to target audience information and other such parameters. The provider may be able to pause or stop a campaign that is running at any time. If the campaign is stopped, then the SCD system may be configured to calculate the amount spent on the campaign up to the point the campaign was stopped, and place a credit in the sum of the balance remaining to the account of the provider by or through an escrow account mechanism. The provider may be able to keep the credit on his account for future campaigns or request the credit be returned in the form, for example, of a refund. The provider may be able to run multiple campaigns simultaneously.

Particular embodiments may include components or steps enabling a provider to carry out post campaign processes. For example, after completion of a campaign, whether it be, for example, as a result of the provider stopping the campaign or the budget being reached, the provider may be sent a notification. The SCD system may be configured to calculate, for example by way of a CPU element, the amount spent on the campaign and place the sum of any balance remaining as a credit to the account of the provider. The provider may then be able to review analytical information concerning the campaign to ascertain the effectiveness of the campaign as an added value or pay for market data analysis. The provider may be able to make modifications to an ongoing campaign and/or restart it as required.

Preferred embodiments of a system and method in accordance with the present invention may allow a recipient to set up a recipient account, watch streaming content, receive an accounting, and receive incentives for promoting the application to other users.

Certain typical embodiments may include components or steps enabling a provider to set up a recipient account. By way of example, the recipient may visit conventional online mobile App stores to download, for example, free-of-charge, an SCD system viewer application. The application may then be loaded onto a recipient device. The first time it the App is started, it may be configured to ask the recipient whether he has an existing recipient account or wishes to open a new one. In certain preferred embodiments, although a recipient can have multiple devices linked to one account, he may only be able to run one copy of the application at any one time. In particular preferred embodiments, if the recipient has an existing account, then the information concerning his account may be transferred to the device. If the recipient does not have an account, then the application may guide him through setting up a new account. The recipient may be asked to provide details of where he wishes payment to be sent too (e.g., a “cash account”). This payment may be made, for example, to a conventional e-commerce payment processing account, a credit or debit card account, the recipient's cell-phone account or any other account that will allow SCD payments to be received.

Particular embodiments may include components or steps enabling a recipient to watching streaming content. For example, the recipient may start the application and the application may then stream content to the recipient device sequentially. The recipient may earn money for every impression streamed to his device and (where applicable) every click he makes. The amount of money paid to the recipient may be a selected fraction or percentage of the amount charged by the system to the provider. For example, the system may pay the recipient one third the amount charged to the provider for streaming of a particular amount of content viewed. A counter may display the amount of money earned by the recipient for the period on a per-view basis. In preferred embodiments, the recipient may be able to pause, restart and rewind content. The recipient may also be able to search for content that is of particular interest, e.g., cars, holidays, etc. When certain content allows, a recipient may be able to click on content which will take the recipient to a website, leave rating feedback and/or cause some other event to occur, e.g., a coupon to be downloaded to the device to be redeemed later on. If the recipient feels any content is not suitable for streaming, he may flag the content as inappropriate. This will register on the SCD system for review later. The recipient may leave the application to continue streaming content or he can quit the application at any time and return to it later on.

Certain embodiments may include components or steps enabling a provider receive an accounting. For example, the recipient may review content watched and money earned. In embodiments, the recipient may also order money (e.g., up to the amount in his recipient account) to be transferred to his cash account. A handling fee may be charged for each transfer made.

Particular embodiments may include components or steps enabling a recipient to be rewarded for recommending SCD to friends and family by way of a bonus to his recipient account. For example, such a payment may be made for each new member referred by the recipient who open an account and uses the SCD system.

From a system perspective, certain preferred embodiments may include components or processes which improve the experience of the content provider and content recipient alike. For example, the content from every provider may be automatically checked for nudity and obscenity. The campaign of every new provider may be checked to ensure quality and suitability before it is allowed to be streamed. If the SCD receives complaints concerning content, the content may be flagged for manual verification and may be subject to automatic stoppage in the event that complaints are received from a specific number of individual recipients, for example, three separate recipients. If a provider continues to stream inappropriate content, that provider may be banned for example, on the third occasion his content is stopped and fees held or forfeited. Information may be collected from the device and account of the recipient and used to target campaigns and content. Recipients may get real time access to a content provider's portals, website, application, products and product offerings through streamtime or end of commercial interaction with the application.

To facilitate certain steps, procedures and processes discussed herein, embodiments may comprise one or more data storage elements, server elements, processor elements, firewalls, communication devices, and user interface elements. Depending on the particular embodiment, a data storage element may be relied on to store data in connection with the provider's account, recipient's account, content, campaign parameters and target parameters. A data storage element may be, for example, one or more hard drives, recording media, mass storage devices, removable media, external storage devices, volatile memory, non-volatile memory, flash memory, magnetic storage media, optical storage media, robotic storage, databases, other conventional data storage means, a combination thereof, or the like. Depending on the particular embodiment, a server element may be, for example, one or more database servers, web servers, chat or instant messaging servers, mail servers, file servers, print servers, a combination thereof, or the like. Depending on the particular embodiment, a processor element may be relied on to perform certain calculations. Processor elements may be, for example, CPUs, microprocessors, network processors, communications processors, front-end processors, a combination thereof, or the like. Depending on the particular embodiment, a device may be, for example, a smart phone, a laptop computer, a desktop computer, a tablet computer, a combination thereof, or the like. Depending on the particular embodiment, a user interface may be, for example, a graphical user interface (GUI), web-based interface, web user interface (WUI), touchpad, touch screen, command line interface, direct manipulation interface, computer keyboard, computer mouse, a combination thereof, or the like.

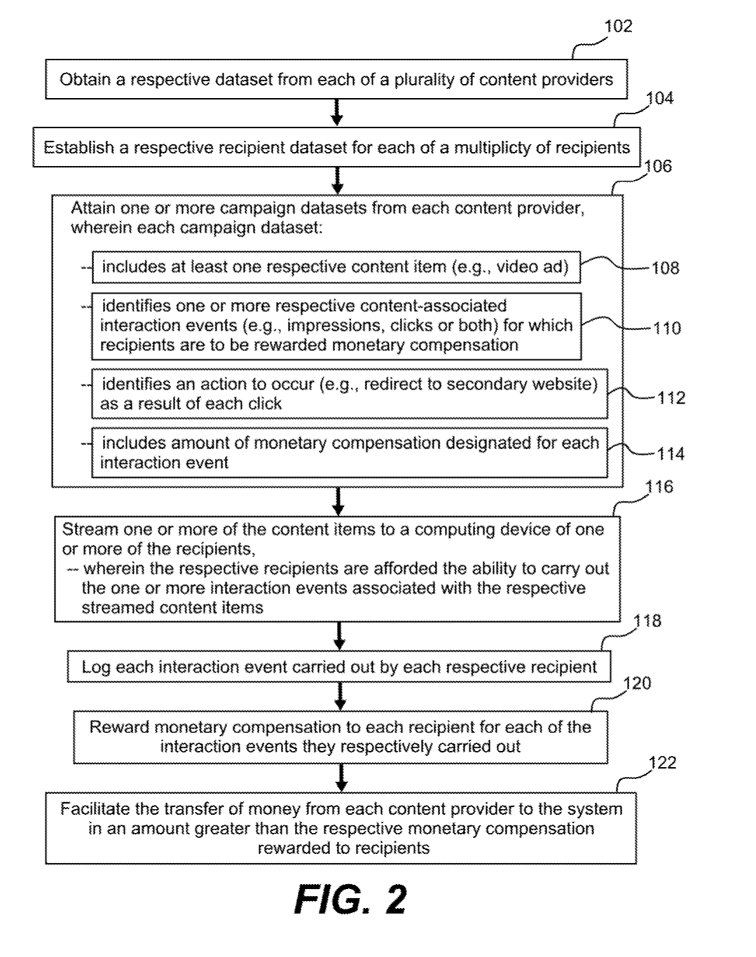

FIG. 2 illustrates one or more example embodiments of a method of operating a streaming content delivery system, comprising several steps. At block 102, a respective provider dataset may be obtained from each of a plurality of content providers. Each provider dataset may include, for example, information enabling the transfer of money between the respective content provider and the system (e.g., specific credit card data, debit card data or a credit account number of the respective content provider). At block 104, a respective recipient dataset may be established for each of a multiplicity of recipients. Each recipient dataset may include, for example, information enabling the transfer of money to a respective recipient cash account. At block 106, one or more campaign datasets may be obtained from each content provider, wherein each campaign dataset preferably includes at least one respective content item (e.g., a video advertisement) and may identify one or more respective content-associated interaction events (e.g., impressions, clicks or both) for which recipients are to be rewarded monetary compensation. At block 116, one or more of the content items may preferably be streamed to a computing device of one or more of the recipients, wherein the respective recipients viewing the content items are afforded the ability to carry out the one or more interaction events associated with the respective streamed content items. At block 118, each interaction event carried out by each respective recipient may be logged. At block 120, monetary compensation may be rewarded to each recipient for each of the interaction events they respectively carried out. At block 122, transfer of money from each content provider to the system may be facilitated in an amount greater than the respective monetary compensation rewarded to recipients.

In particular embodiments of the method shown, for example, in FIG. 2, each campaign dataset in which the identified interaction events include clicks, the campaign dataset may further identify an action to occur as a result of each click (see, for example, block 112). In such embodiments the action may be, for example, a redirect of the recipient's computing device to a secondary web address.

As illustrated in block 114 of FIG. 2, in certain embodiments of a method the monetary compensation may be a respective amount designated for each interaction event. Such designated amounts may preferably be included within the respective campaign datasets. Moreover, in such embodiments, content items having higher designated monetary compensation amounts may be prioritized to be streamed before content items having lower designated monetary compensation amounts.

Particular embodiments of a method such as the one illustrated in FIG. 2 may further comprise continuously tracking the total monetary compensation rewarded to all recipients in connection with each campaign dataset; and ceasing streaming the content items of respective campaign datasets in which the total rewarded monetary compensation reaches the respective campaign budget. In such embodiments, each campaign budget may preferably be defined within a respective campaign dataset.

In certain embodiments of a method such as the one illustrated in FIG. 2, each content item may have a respective temporal length, each temporal length being divisible into multiple respective blocks of time. In such embodiments, the respective monetary compensation may, for example, only be rewarded for one interaction event carried out by the respective recipient within each block of time.

Preferred methods may further comprise the step of scanning each content item to ensure it is devoid of nudity and obscenity as a precondition to its respective step of streaming 116. The same or other methods in according to the present invention may further comprise the step of providing a content search function by which each recipient can enter one or more search terms, thereby resulting, for example, in the content items which are consistent with the respective search terms being streamed to the computing device of the respective recipient.

Certain preferred embodiments may further comprise the step of furnishing a software application downloadable to the computing devices of one or more of the recipients, wherein the software application may be configured to allow the respective recipients to view respective streamed content items, carry out a respective interaction event, and monitor their respective rewarded monetary compensation.

In particular preferred embodiments, one or more recipient datasets may include respective recipient parameters, one or more of the campaign datasets may include target audience parameters, and the respective content items may be streamed to recipients for which one or more recipient parameters match the target audience parameters. In such embodiments, the recipient parameters may include one or more of the demographics, location and interests of the respective recipient.

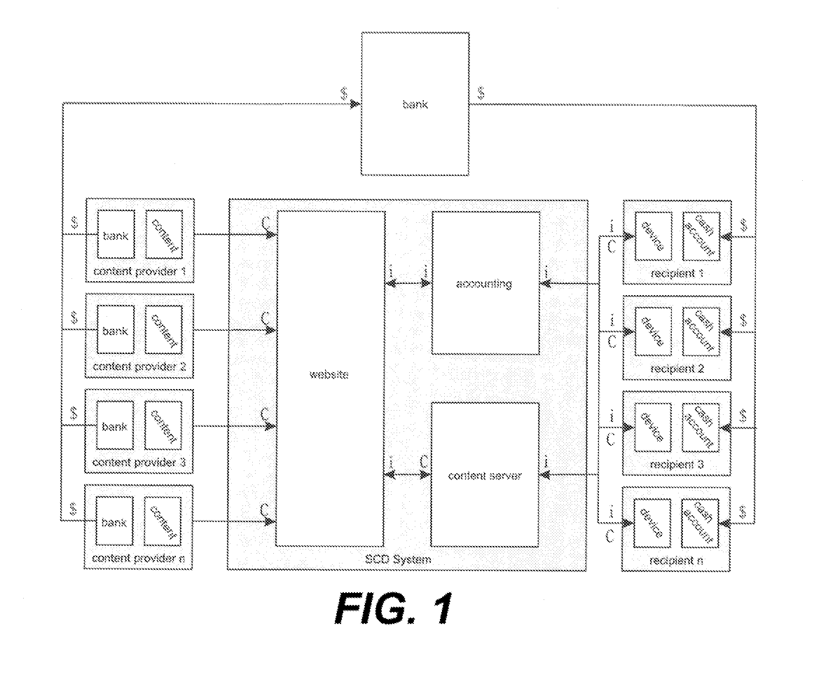

As illustrated, for example, in FIG. 1, certain embodiments of a streaming content delivery system in accordance with the present invention may comprise a content server, an accounting database and a website server in communication with the content server and accounting database. In such embodiments, the system may be configured to perform a method illustrated for example in FIG. 2, or otherwise described elsewhere herein. In such embodiments of a system, one or more of the steps of obtaining 102, establishing 104, and attaining 106 may be performed by way of the website server or its equivalent. Moreover, the step of streaming 116 may preferably be performed by way of the content server. The step of rewarding 120 may be performed by way of the accounting database.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of operating a streaming content delivery system, the method comprising the steps of:
obtaining a respective provider dataset from each of a plurality of content providers, each provider dataset including information enabling the transfer of money between the respective content provider and the system;
establishing a respective recipient dataset for each of a multiplicity of recipients, each recipient dataset including information enabling the transfer of money to a respective recipient cash account;
attaining one or more campaign datasets from each content provider, wherein each campaign dataset includes at least one respective content item and identifies one or more respective content-associated interaction events for which recipients are to be rewarded monetary compensation;
streaming one or more of the content items to a computing device of one or more of the recipients, wherein the respective recipients are afforded the ability to carry out the one or more interaction events associated with the respective streamed content items;
logging each interaction event carried out by each respective recipient;
rewarding monetary compensation to each recipient for each of the interaction events they respectively carried out; and
facilitating the transfer of money from each content provider to the system in an amount greater than the respective monetary compensation rewarded to recipients.

2. A method as defined in claim 1 wherein the identified interaction events for each campaign dataset include impressions, clicks or both.

3. A method as defined in claim 1 wherein for each campaign dataset in which the identified interaction events include clicks, the campaign dataset further identifies an action to occur as a result of each click.

4. A method as defined in claim 3 wherein the action is a redirect to a secondary web address.

5. A method as defined in claim 1 wherein the monetary compensation is a respective amount designated for each interaction event, the designated amounts being included within the respective campaign datasets.

6. A method as defined in claim 5 wherein in the step of steaming, content items having higher designated monetary compensation amounts are prioritized to be streamed before content items having lower designated monetary compensation amounts.

7. A method as defined in claim 1 wherein one or more of the content items is video advertisement.

8. A method as defined in claim 1 wherein the information enabling the transfer of money between the respective content provider and the system is specific credit card data, debit card data or a credit account number of the respective content provider.

9. A method as defined in claim 1 further comprising the steps of:
continuously tracking the total monetary compensation rewarded to all recipients in connection with each campaign dataset; and
ceasing streaming the content items of respective campaign datasets in which the total rewarded monetary compensation reaches the respective campaign budget;
wherein each campaign budget is defined within a respective campaign dataset.

10. A method as defined in claim 1 wherein each content item has a respective temporal length, each temporal length being divisible into multiple respective blocks of time, and the respective monetary compensation is only rewarded for one interaction event carried out by the respective recipient within each block.

11. A method as defined in claim 1 further comprising the step of:
scanning each content item to ensure it is devoid of nudity and obscenity as a precondition to its respective step of streaming.

12. A method as defined in claim 1 further comprising the step of:
providing a content search function by which each recipient can enter one or more search terms, thereby resulting in the content items which are consistent with the respective search terms being streamed to the computing device of the respective recipient.

13. A method as defined in claim 1 further comprising the step of:
furnishing a software application downloadable to the computing devices of one or more of the recipients, wherein the software application is configured to allow the respective recipients to view respective streamed content items, carry out a respective interaction event, and monitor their respective rewarded monetary compensation.

14. A method as defined in claim 1 wherein:
one or more recipient datasets include respective recipient parameters;
one or more of the campaign datasets include target audience parameters, and
the respective content items are streamed to recipients for which one or more recipient parameters match the target audience parameters.

15. A method as defined in claim 14 wherein the recipient parameters include one or more of the demographics, location and interests of the respective recipient.

16. A streaming content delivery system comprising:
a content server;
an accounting database; and
a website server in communication with the content server and accounting database;
wherein the system is configured to perform a method comprising the steps of:
obtaining, by way of the website server, a respective provider dataset from each of a plurality of content providers, each provider dataset including information enabling the transfer of money between the respective content provider and the system;
establishing, by way of the website server, a respective recipient dataset for each of a multiplicity of recipients, each recipient dataset including information enabling the transfer of money to a respective recipient cash account;
attaining, by way of the website server, one or more campaign datasets from each content provider, wherein each campaign dataset includes at least one respective content item and identifies one or more respective content-associated interaction events for which recipients are to be rewarded monetary compensation;
streaming, by way of the content server, one or more of the content items to a computing device of one or more of the recipients, wherein the respective recipients are afforded the ability to carry out the one or more interaction events associated with the respective streamed content items;
logging each interaction event carried out by each respective recipient;
rewarding, by way of the accounting database, monetary compensation to each recipient for each of the interaction events they respectively carry out; and
facilitating the transfer of money from each content provider to the system in an amount greater than the respective monetary compensation rewarded to recipients.

17. A system as defined in claim 16 wherein the method further comprises the steps of:
continuously tracking the total monetary compensation rewarded to all recipients in connection with each campaign dataset; and
ceasing the streaming of content items of respective campaign datasets when the total monetary compensation pertaining to those campaign datasets reaches a respective campaign budget;
wherein the campaign budgets are defined within respective campaign datasets.

18. A system as defined in claim 16 wherein one or more of the content items is video advertisement.

19. A system as defined in claim 16 wherein:
one or more recipient datasets include respective recipient parameters, the recipient parameters including one or more of the demographics, location and interests of the respective recipient;
one or more of the campaign datasets include target audience parameters, and
the respective content items are streamed to recipients for which one or more recipient parameters match the target audience parameters.

20. A system as defined in claim 16 wherein:
wherein the monetary compensation is a respective amount designated for each interaction event, the designated amounts being included within the respective campaign datasets; and
in the step of steaming, content items having higher designated monetary compensation amounts are prioritized to be streamed before content items having lower designated monetary compensation amounts.
